(19) United States
(12) Patent Application Publication
(10) Pub. No.: US 2026/0203081 A1
(43) Pub. Date: Jul. 16, 2026

(54) SUGGESTING AND VALIDATING USER INTERFACE ELEMENTS IN ACCORDANCE WITH A DESIGN SYSTEM

(71) Applicant: Dell Products L.P., Round Rock, TX (US)

(72) Inventors: Janardan Revuru, Bangalore (IN); Vaneeswaran Natrayan, Erode (IN)

(21) Appl. No.: 19/024,789

(22) Filed: Jan. 16, 2025

(51) Int. Cl. G06F 9/451

(52) U.S. Cl. CPC G06F 9/451

(57) ABSTRACT

A method for managing user interface (UI) generation includes: receiving a request from a user via a computing device, in which the request includes user input; analyzing the request to: determine a type of the user input, and identify a mode to implement; making a determination, based on analyzing the request, that a validation mode needs to be implemented; based on the determination, analyzing the user input to extract information, in which the information is provided to a rule engine; receiving, in response to providing the information, a validation result with respect to UI elements specified in the information from the rule engine, in which the validation result includes a compliance score of each UI element; and initiating display of the validation result to the user.

### BACKGROUND

Computing devices may include any number of internal components such as processors, memory, and persistent storage. Computing resources associated with (e.g., used by) each of these internal components may be used to generate, store, and backup data. Such utilization of computing resources may affect the overall performance of the computing devices.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a diagram of a system in accordance with one or more embodiments disclosed herein.

FIG. 2 shows a diagram of an infrastructure node in accordance with one or more embodiments disclosed herein.

FIG. 3.1 shows an example user interface (UI) elements design guideline on language usage in accordance with one or more embodiments disclosed herein.

FIG. 3.2 shows an example UI elements design guideline on button styles and usage in accordance with one or more embodiments disclosed herein.

FIG. 3.3 shows an example range of UI elements based on a list of options for a user to select in accordance with one or more embodiments disclosed herein.

FIG. 4.1-4.2 show a method for managing UI generation (and/or validation) in accordance with one or more embodiments disclosed herein.

FIG. 5 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, the generation/creation of UI goes through multiple stages, starting from requirements to high-fidelity mocks, which is a complex and time-consuming process. After an initial product (e.g., an initial UI product) is built, addition of a newer feature (e.g., a newer UI element) requires user experience (UX) design teams to ensure that the addition of the newer feature is compliant with an organizational design system (including various guidelines). An organizational design system may include a set of themes, typography, layouts, color schemes, and/or accessibility guidelines that are specific to the organization.

From a different perspective, ensuring compliance with a specific design system is a time consuming and error prone process. The problem/issue arises as developers (e.g., people, engineers, administrators, users, etc.), who may constitute more than 90% of the overall software development in a related organization, are not trained for UX. Activities such as selecting the right color code from a range of color palette and/or the correct use for a language to make the language inclusive may frustrate the developers (cause them to make mistakes), which, at the end, may delay a projected manufacturing/development timeline of a related product and affect the organization's trusted branding value.

For at least the reasons discussed above and without requiring resource-intensive efforts (e.g., time, engineering, etc.), a fundamentally different approach/framework is needed (e.g., a framework that provides enhancements in (i) designing UIs (e.g., based on certain guidelines/rules) and (ii) verification/validation of already built UIs (e.g., against certain guidelines) for developers/users/testers).

Embodiments disclosed herein relate to methods and systems to manage UI generation (and/or validation) in accordance with a design system (including/specifying related organization guidelines). As a result of the processes discussed below, one or more embodiments disclosed herein advantageously ensure that: (i) the framework provides enhancements in (a) designing UIs (e.g., based on certain guidelines) and (b) verification of already built UIs (e.g., against certain guidelines) for developers/users; (ii) multiple elements/items (e.g., UI elements, color schemes, texts, etc.) to be used while generating a UI (for example, for a web application) are inferred upon receiving (and analyzing against related organizational guidelines) a user input (over a computing device); (iii) upon receiving a user input (over a computing device), UI elements (e.g., used in a web application) are validated (by parsing each element, color schemes, texts, etc., against related organizational guidelines); (iv) the framework enables users (e.g., UI developers, UI testers, etc.) to design user friendly products (e.g., UIs, UI products, etc.) while adhering to related organizational guidelines (e.g., while being adhered to mandatory compliance requirements if the product needs to be manufactured/designed for federal customers); (v) based on (iv), the users (and their companies) can be protected from causing branding violations as a result of not adhering to related organizational guidelines; (vi) the framework provides reduced dependence of engineering (that needs to done by corresponding UI developers) for incremental UX workloads; and/or (vii) the framework improves customer experience by fixing UI related issues (e.g., text issues, color issues, etc.) in a short period of time.

The following describes various embodiments disclosed herein.

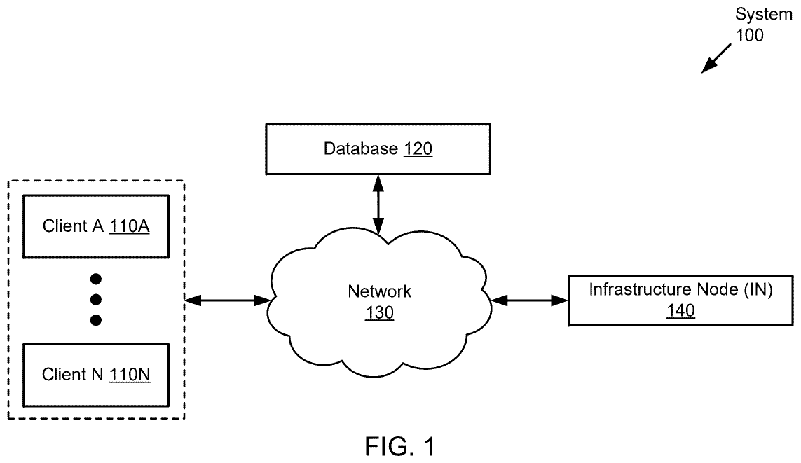

FIG. 1 shows a diagram of a system (100) in accordance with one or more embodiments disclosed herein. The system (100) includes any number of clients (e.g., Client A (110A), Client N (110N), etc.), a database (120), any number of infrastructure nodes (INs) (e.g., 140), and a network (130). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110N, etc.), the database (120), the IN (140), and the network (130) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110N, etc.) and the IN (140) are shown to be operatively connected through a communication network (e.g., 130), the clients (e.g., 110A, 110N, etc.) and the IN (140) may be directly connected (e.g., without an intervening communication network).

Further, the functioning of the clients (e.g., 110A, 110N, etc.) and the IN (140) is not dependent upon the functioning and/or existence of the other components (e.g., devices) in the system (100). Rather, the clients and the IN may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

As used herein, a “volume” may be analogous to a logical unit number in a storage area network (SAN), in which a volume may be a subset of the database's (120) capacity presented by a storage node of the storage as a local block device. A volume's data may be evenly distributed across all storage resources of the database (120), for example, according to a data layout selected for the database (120).

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

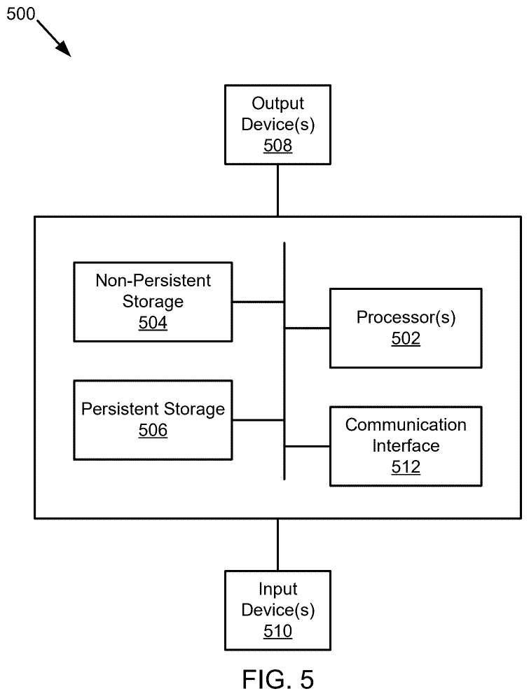

In one or more embodiments, the system (100) may be a distributed system (e.g., a data processing environment) and may deliver at least computing power (e.g., real-time (on the order of milliseconds (ms) or less) network monitoring, server virtualization, data deduplication, etc.), storage capacity (e.g., data backup), and data protection (e.g., software-defined data protection, disaster recovery, etc.) as a service to users (e.g., people) of clients (e.g., 110A, 110N, etc.). For example, the system may be configured to organize unbounded, continuously generated data into a data stream. The system (100) may also represent a comprehensive middleware layer executing on computing devices (e.g., 500, FIG. 5) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users'site using the clients (e.g., 110A, 110N, etc.)) and other computations remotely (e.g., away from the users'site using the IN (140)) from the users. By doing so, the users may utilize different computing devices (e.g., 500, FIG. 5) that have different quantities of computing resources (e.g., processing cycles, memory, storage, etc.) while still being afforded consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IN (140)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the IN (140). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or a computing device operated by one or more individuals of (or employed by) an organization. Examples of said individual(s) may include, but not limited to, any organization executive(s) (e.g., chief executive officer (CEO), chief financial officer (CFO), etc.), and any employee(s) in the accounting/finance team of the organization (e.g., a collector person). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the IN (140) and/or the database (120). For example, the clients may issue requests to the IN to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by the IN. When the clients interact with the IN, data that is relevant to the clients may be stored (temporarily or permanently) in the IN.

In one or more embodiments, a client (e.g., 110A, 110N, etc.) may be capable of, e.g.,: (i) collecting users'inputs, (ii) correlating collected users'inputs to the computer-implemented services to be provided to the users, (iii) communicating with the IN (140) and/or the database (120) that perform computations necessary to provide the computer-implemented services, (iv) using the computations performed by, for example, the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the IN (140), the database (120), etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8 GB of PMEM and 1 CPU with 16 cores. Other different computational capabilities of the clients not listed above may also be considered without departing from the scope of the embodiments disclosed herein.

Further, in one or more embodiments, a client (e.g., 110A, 110N, etc.) may be implemented as a computing device (e.g., 500, FIG. 5). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., UI developers, administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing virtualization technology. In one or more embodiments, an administrator may be a user with permission (e.g., a user that has root-level access) to make changes to the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 500, FIG. 5) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, the IN (140) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (140) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the storage for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or machine learning (ML) models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the database (120); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or to the storage; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (140) may communicate with, for example, the database (120) and/or other storage devices in the system (100).

As described above, the IN (140) may be capable of providing a range of functionalities/services to the users of the clients (e.g., 110A, 110N, etc.). However, not all users may be allowed to receive all the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

For example, the priority (e.g., the user access level) of a user may be used to determine how to manage computing resources of the IN (140) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g. a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN (140) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) the IN (140) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

As used herein, a “policy” is a collection of information, such as a backup policy or other data protection policy, that includes, for example (but not limited to): identity of source data that is to be protected, backup schedule and retention requirements for backed up source data, identity of a service level agreement (SLA) (or a rule) that applies to source data, identity of a target device where source data is to be stored, etc.

As used herein, the term “backup” is intended to be broad in scope. In this manner, example backups (in connection with which embodiments disclosed herein) may be employed include (but not limited to): full backups, partial backups, clones, snapshots, incremental backups, differential backups, etc.

As used herein, “data retention” is a period of time, with a definite start and end, within which the data should be retained in storage/database (e.g., 120). For example, a set of user requirements and/or technical considerations (e.g., security considerations, performance considerations, etc.) of a data center may be used to generate a data retention policy specifying that user data should be retained in the database for seven years.

As used herein, a “rule” is a guideline used by an SLA component to select a particular target device (or target devices), based on the ability of the target device to meet requirements imposed by the SLA. For example, a rule may specify that an HDD having a particular performance parameter should be used as the target device. A target device selected by the SLA component may be identified as part of a backup policy or other data protection policy.

Further, while a single IN (e.g., 140) is considered above, the term “node” includes any collection of systems or sub-systems that individually or jointly execute a set, or multiple sets, of instructions to provide one or more computer-implemented services. For example, a single IN/server/host may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (140) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, the IN (140) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

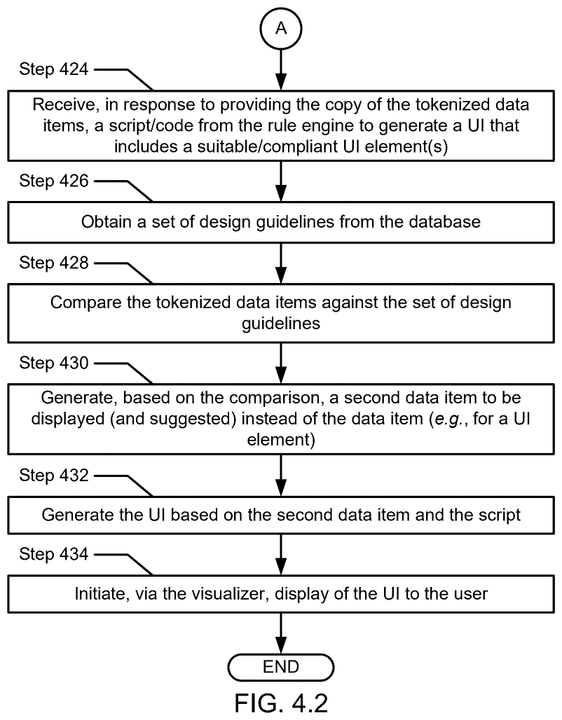

One of ordinary skill will appreciate that the IN (140) may perform other functionalities without departing from the scope of the embodiments disclosed herein. In one or more embodiments, the IN (140) may be configured to perform (in conjunction with the database (120)) all, or a portion, of the functionalities described in FIG. 4.1-4.2.

In one or more embodiments, the IN (140) may be implemented as a computing device (e.g., 500, FIG. 5). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN (140) may also be implemented as a logical device.

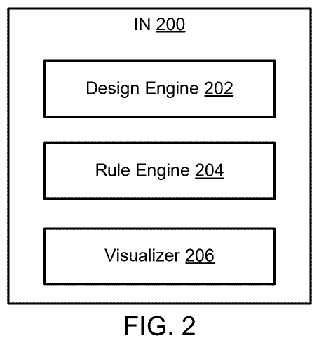

In one or more embodiments, the IN (140) hosts, at least, a design engine (e.g., 202, FIG. 2), a rule engine (e.g., 204, FIG. 2), and a visualizer (e.g., 206, FIG. 2). The design engine, the rule engine, and the visualizer may be physical or logical computing devices/entities. Additional details of the design engine, the rule engine, and the visualizer are described below in reference to FIG. 2.

In the embodiments of the present disclosure, the database (120) is demonstrated as a separate entity from the IN (140); however, embodiments disclosed herein are not limited as such. The database (120) may be demonstrated as a part of the IN (e.g., as deployed to the IN (140)).

Turning now to the database (120), the database (120) may provide long-term, durable, high read/write throughput data storage/protection with near-infinite scale and low-cost. The database (120) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. For example, the database (120) may store data (e.g., backup data; file system metadata; assets; rules and/or procedures for performing backups of the IN (140); etc.). Further, the database (120) may also occupy a portion of a physical storage/memory device or, alternatively, may span across multiple physical storage/memory devices. The database (120) may include other and/or additional functionalities without departing from embodiments disclosed herein.

In one or more embodiments, the database (120) may be implemented using physical devices that provide data storage services (e.g., storing data and providing copies of previously stored data). The devices that provide data storage services may include hardware devices and/or logical devices. For example, the database (120) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (120) may include a memory device (e.g., a dual in-line memory device), in which data is stored and from which copies of previously stored data are provided. As yet another example, the database (120) may include a persistent storage device (e.g., an SSD), in which data is stored and from which copies of previously stored data is provided. As yet another example, the database (120) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (120) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the database (120) may store/log/record unstructured and/or structured data that may include (or specify), for example (but not limited to): a backup policy/practice; telemetry data including past and present device usage of one or more computing devices; data for execution of applications/services including IN applications and associated end-points; corpuses of annotated data used to build/generate and train processing classifiers for trained ML models; linear, non-linear, and/or ML model parameters; data tags; an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; an identifier of a user (e.g., a unique string or combination of bits associated with a particular user) who initiated a backup (via a client); a distributed model identifier that uniquely identifies a distributed model; a user activity performed on a data item; a cumulative history of user/administrator activity records obtained over a prolonged period of time; a setting (and a version) of a mission critical application executing on the IN (140); configuration information associated with the IN (140); a job detail of a job that has been initiated by the IN; a type of the job (e.g., a non-parallel processing job, a parallel processing job, an analytics job, etc.); information associated with a hardware resource set (discussed below) of the IN; a completion timestamp encoding a date and/or time reflective of the successful completion of a job; a time duration reflecting the length of time expended for executing and completing a job; a backup retention period associated with an asset (e.g., data item); a status of a job (e.g., how many jobs are still active, how many jobs are completed, etc.); a number of requests handled (in parallel) per minute (or per second, per hour, etc.) by the IN (140); a number of errors encountered when handling a job (e.g., a backup process); a documentation that shows how the IN (140) performs against an SLO and/or an SLA; a set of requests received by the IN (140); a set of responses provided (by the IN) to those requests; information regarding an administrator (e.g., a high priority trusted administrator, a low priority trusted administrator, etc.) related to a job; tier/level information of a user (e.g., a high-privileged user, a low-privileged user, etc.); a geographic location (e.g., a country) associated with the user; a timestamp showing when a specific request is processed by the IN (140); computing resource details (including details of hardware components and/or software components) and an IP address of an IN (e.g., 140) hosting an application where a specific request is processed; information with respect to historical metadata (e.g., system logs, applications logs, telemetry data including past and present device usage of one or more computing devices in the system (100), etc.); computing resource details and an IP address of a client that sent a specific request (e.g., to the IN (140)); an existing knowledge base (KB) article; a technical support history documentation of a customer/user; a port's user guide; a port's release note; a community forum question and its associated answer; a catalog file of an application upgrade; details of a compatible OS version for an application upgrade to be installed; an application upgrade sequence; a solution or a workaround document for a software failure; one or more lists that specify which computer-implemented services should be provided to which user (depending on a user access level of a user); a fraud report for an invalid user; a set of SLAs (e.g., an agreement that indicates a period of time required to retain a profile of a user); information with respect to a user/customer experience; an organization specific design system (described below); etc.

In one or more embodiments, information associated with a hardware resource set (e.g., including at least resource related parameters) may specify, for example (but not limited to): a configurable CPU option (e.g., a valid/legitimate vCPU count for the IN (140)), a configurable network resource option (e.g., enabling/disabling single-root input/output virtualization (SR-IOV) for the IN (140)), a configurable memory option (e.g., maximum and minimum memory for the IN (140)), a configurable GPU option (e.g., allowable scheduling policy and/or virtual GPU (vGPU) count combinations for the IN (140)), a configurable DPU option (e.g., legitimacy of disabling inter-integrated circuit (I2C) for the IN (140)), a configurable storage space option (e.g., a list of disk cloning technologies across one or more INs in the system (100)), a configurable storage I/O option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per IN in the system (100), a wake on LAN support configuration (e.g., supported/enabled, not supported/disabled, etc.), a vGPU count per IN in the system (100), a type of a vGPU scheduling policy (e.g., a “fixed share” vGPU scheduling policy), a storage mode configuration (e.g., an enabled high-performance storage array mode), etc.

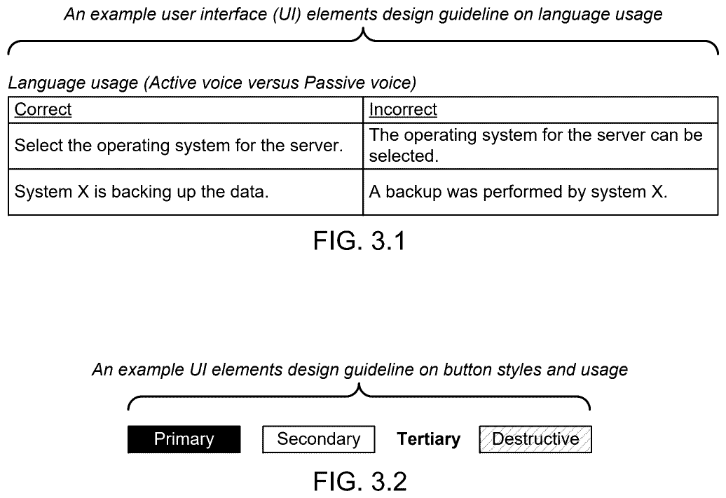

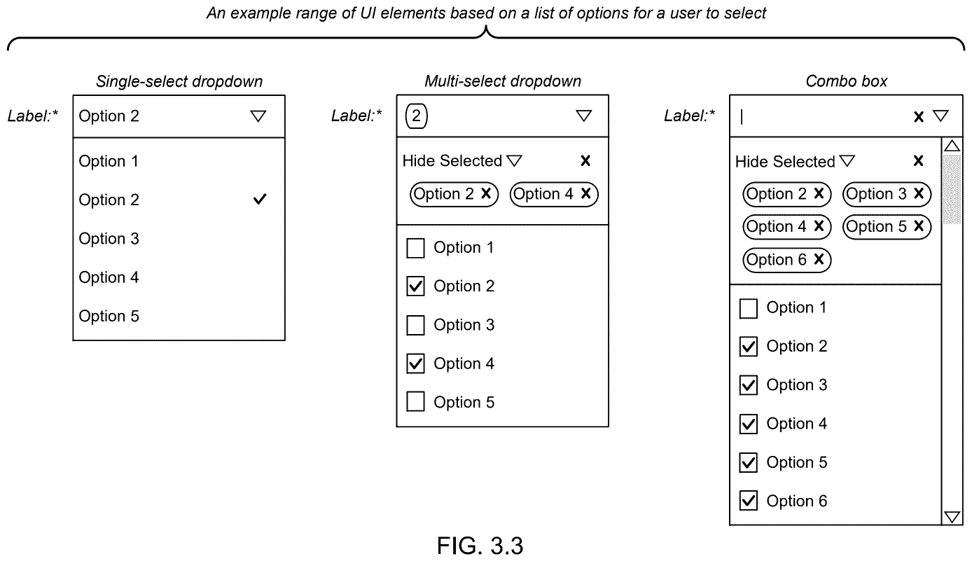

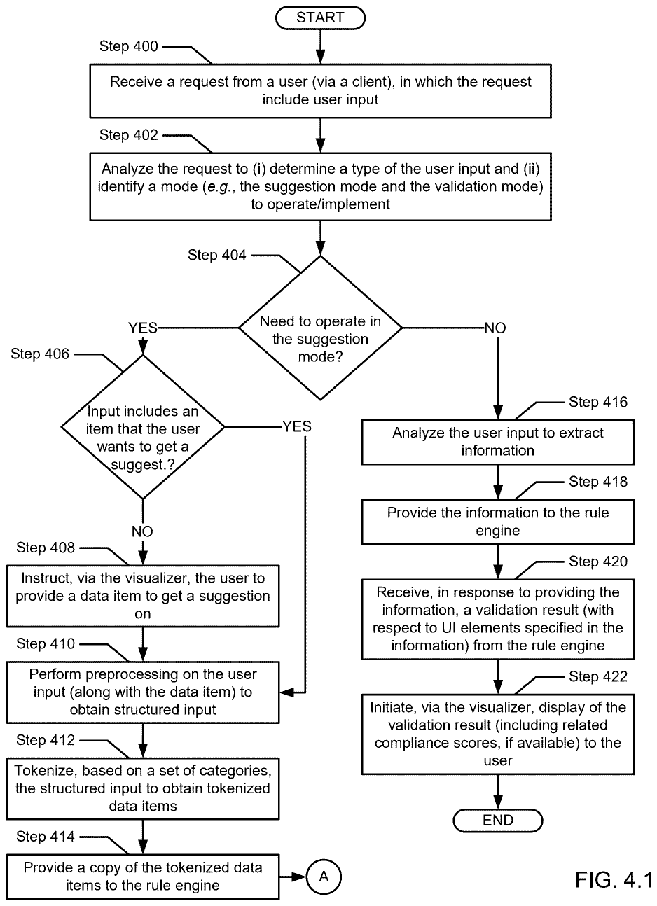

In one or more embodiments, an organization specific design system (a set of UI (or “UI elements”) design guidelines/principles/rules (e.g., that needs to be adhered based on a geographical location/region of a customer)) may specify, for example (but not limited to): a set of language checks, a set of font options, a set of standard text messages, a set of UI elements, a set of color schemes/themes, a set of UI background settings (e.g., a set of layouts, frameworks, etc.), a set of UI/UX design principles, a UI elements design guideline on language usage (e.g., inclusive language usage) (see FIG. 3.1), a UI elements design guideline on button styles and usage (see FIG. 3.2), a range of UI elements based on a list of options for a user to select (see FIG. 3.3), a set of user stories (e.g., user requirements), a set of user personas (e.g., a set of user types), a set of accessibility guidelines (e.g., with respect to text font, text color, text size, text color contrast, etc.), a set of branding guidelines, a set of internationalization guidelines (e.g., I18N) to design products to be easily adapted for different audiences/customer/users, a set of localization guidelines (e.g., L10N) to adapt a product to the cultural, linguistic, and other requirements of a target customer market (e.g., based on a geographical location of a customer), a set of usage analytics, a list of words that is not allowed and alternatives to those words, etc.

In one or more embodiments, metadata (e.g., system logs, application logs, etc.) may be obtained (or dynamically fetched) as they become available (e.g., with no user manual intervention), or by the design engine (e.g., 202, FIG. 2) polling a corresponding client (e.g., 110A) (by making schedule-driven/periodic application programming interface (API) calls to the client without affecting the client's ongoing production workloads) for newer metadata, for example, before analyzing a health state of the client. Based on receiving the API calls from the engine, the client may allow the engine to obtain the metadata.

In one or more embodiments, the metadata may be obtained (or streamed) continuously as they generated, or they may be obtained in batches, for example, in scenarios where (i) the engine (e.g., 202, FIG. 2) receives a metadata analysis request (or a health state check request for a client), (ii) another IN of the system (100) accumulates the metadata and provides them to the engine at fixed time intervals, or (iii) the database (120) stores the metadata and notify the engine to access the metadata from the database. In one or more embodiments, metadata may be access-protected for a transmission from the database (120) to the engine (e.g., 202, FIG. 2), e.g., using encryption.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the database (120), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by vendors) and/or by the administrators based on, for example, newer (e.g., updated) versions of external information. The unstructured and/or structured data may also be updated when, for example (but not limited to): a set of newer backup rules is received, an ongoing backup process is fully completed, a state of the IN (140) is changed, etc.

While the database (120) has been illustrated and described as including a limited number and type of data, the database (120) may store additional, less, and/or different data without departing from the scope of the embodiments disclosed herein. One of ordinary skill will appreciate that the database (120) may perform other functionalities without departing from the scope of the embodiments disclosed herein.

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN, the storage nodes, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

While FIG. 1 shows a configuration of components, other system configurations may be used without departing from the scope of the embodiments disclosed herein.

Turning now to FIG. 2, FIG. 2 shows a diagram of an IN (200) in accordance with one or more embodiments disclosed herein. The IN (200) may be an example of the IN discussed above in reference to FIG. 1. The IN (200) includes the design engine (202), the rule engine (204), and the visualizer (206). The IN (200) may include additional, fewer, and/or different components without departing from the scope of the embodiments disclosed herein. Each component may be operably connected to any of the other components via any combination of wired and/or wireless connections. Each component illustrated in FIG. 2 is discussed below.

In one or more embodiments, as being a physical computing device or a logical computing device, the design engine (202) may include functionality to, at least: (i) upon receiving a request (e.g., text input, a questionnaire, an image of a UI mock, an image of a hypertext markup language (HTML) page, etc.) from a user (e.g., a UI developer who has experience on developing UIs or has no experience on developing UIs) and by operating in a “suggestion mode”, design/suggest a UI based on a related design system (e.g., based on related UI design guidelines, based on related organizational guidelines, etc.); (ii) upon receiving a request (e.g., a text, a uniform resource locator (URL) of a web page, a screenshot of an already built UI, etc.) from a user (e.g., a UI compliance tester/auditor who has experience on testing UIs or has no experience on testing UIs) and by operating in a “validation mode”, validate a UI (e.g., an already generated UI) based on a related design system (so that the user has less responsibility to perform the validation because there may be too much design guidelines to validate/focus (depending on a customer, the customer's geographical location, etc.)); and/or (iii) while operating in the suggestion mode or in the validation mode, ensure that the generated or validated UIs are 100% compliant with a related organizational guideline for a faster product manufacturing and maximum customer satisfaction (e.g., ensuring that an addition of a newer UI element/feature is 100% compliant with a user accessibility guideline that is requested (by a federal customer) to be adhered/followed).

One of ordinary skill will appreciate that the design engine (202) may perform other functionalities (in conjunction with the rule engine (204)) without departing from the scope of the embodiments disclosed herein. The design engine (202) may be implemented as a computing device using hardware (e.g., any number of integrated circuits for processing computer readable instructions), software (e.g., a computer program), or any combination thereof.

In one or more embodiments, the design engine (202) may take/receive a request/input from a user and, in conjunction with the rule engine (204), process the input. Based on the mode (the suggestion mode or the validation mode) the design engine (202) needs to operate, the design engine (202) (i) may perform validation of a UI (e.g., an already generated UI) (via the visualizer (206)), or (ii) may suggest one or more UI elements and, at the end, generate (and provide) a UI to the user (via the visualizer (206)).

One of ordinary skill will appreciate that the rule engine (204) may perform other functionalities (in conjunction with the design engine (202)) without departing from the scope of the embodiments disclosed herein. The rule engine (204) may be implemented as a computing device using hardware (e.g., any number of integrated circuits for processing computer readable instructions), software (e.g., a computer program), or any combination thereof.

In one or more embodiments, while operating in the suggestion mode and in case of text input (as part of a user request), the design engine (202) may suggest validation of UI elements (for example, a range of UI elements (e.g., a text box, a list box, an alert plane, a single-select dropdown option (see FIG. 3.3), a single-select dropdown option (see FIG. 3.3) a multi-select dropdown option (see FIG. 3.3), a combo option (see FIG. 3.3), etc.), color schemes to be used for the UI elements, and a text to be used in those UI elements may be suggested to the user (for review, via the visualizer (206)) before generating a final UI against a set of UI design guidelines (e.g., branding guidelines, guidelines with respect to inclusive language (or language usage, see FIG. 3.1), guidelines with respect to understandable error messages, etc.).

Further, after a final UI (e.g., a set of web elements, a web framework, etc.) is generated and provided to the user (via the visualizer (206)), the user may request additional changes on the final UI based on one or more requirements (e.g., user requirements, a user story, etc.) that need to be satisfied (e.g., for maximum customer satisfaction). To update the final UI based on the requirements, for example, the design engine (202) may add newer UI controls/buttons (while still adhering to the set of UI design guidelines (e.g., a UI elements design guideline on button styles and usage)) to the final UI.

In one or more embodiments, while the design engine (202) is operating in the suggestion mode, a user may be provided with an option to enter a data item (e.g., an element, a UI element, etc.) to get a suggestion on. For example, if a user wants to show a single message (which is the data item) as an alert/notification on a UI, the user may just write/add/paste a related string and choose “data format” as “alert/notification.” As yet another example, a user may provide an alert text as input to the design engine (202) and select “data format” as “list.” In both examples, after receiving the inputs, the design engine (202) may process/analyze (in conjunction with the rule engine (204)) the inputs against a set of related organizational guidelines.

Further, while the design engine (202) is operating in the validation mode, a user may send a request to the design engine (202) by providing input (e.g., a screenshot of a UI, a URL of a web page, etc.). Upon receiving the input and in conjunction with the rule engine (204), the design engine (202) may analyze the contents of the input and validate the contents against a set of related organizational guidelines (and provide a result of the validation analysis to the user via the visualizer (206)).

In one or more embodiments, the design engine (202) may initiate, for example, displaying of (i) identified/tagged health of a corresponding client (after obtaining telemetry data of the client), (ii) a holistic user profile of a user of the client (e.g., 110A, FIG. 1), (iii) alerts (generated by the design engine) to indicate an overall health status of the client), (iv) a validation result (including related compliance scores, if available) of an already built UI to a related user, and/or (v) a generated UI to a related user via the visualizer (206) (e.g., via a GUI, an API, a programmatic interface, and/or a communication channel of the visualizer). In one or more embodiments, for example, (i) each data item (e.g., identified health (e.g., healthy, unhealthy, etc.) of the client, an engine generated alert, etc.) may be displayed (e.g., highlighted, visually indicated, etc.) with a different color (e.g., red color tones may represent a negative overall health status of the client, green color tones may represent a positive overall health status of the client, etc.), and (ii) one or more useful insights/recommendations with respect to the overall health status of the client may be displayed in a separate window(s) on the visualizer (206) to assist the user/administrator while managing the overall health status of the client (e.g., for a better administrator experience, to help the administrator with respect to understanding the benefits and tradeoffs of selecting different troubleshooting options, etc.).

As used herein, “unhealthy” may refer to a compromised health state (e.g., an unhealthy state), indicating a corresponding entity (e.g., a hardware component, a client, an application, etc.) has already or is likely to, in the future, be no longer able to provide the services that the entity has previously provided. The health state determination may be made via any method based on the aggregated health information without departing from the scope of the embodiments disclosed herein.

Further, the visualizer (206) may include functionality to, e.g.,: (i) obtain (or receive) data (e.g., any type and/or quantity of input) from any source (e.g., a user via a client (e.g., 110A, FIG. 1), the design engine (202), etc.) (and, if necessary, aggregate the data); (ii) based on (i) and by employing a set of linear, non-linear, and/or ML models, analyze, for example, a query to derive additional data; (iii) encompass hardware and/or software components and functionalities provided by the IN (200) to operate as a service over the network (e.g., 130, FIG. 1) so that the visualizer (206) may be used externally; (iv) employ a set of subroutine definitions, protocols, and/or hardware/software components for enabling/facilitating communications between, for example, the design engine (202) and external entities (e.g., clients, administrators, etc.); (v) by generating one or more visual elements, allow an administrator to, at least, interact with a user of a corresponding client; (vi) receive a customer/user profile of a customer and display the customer profile to an administrator (e.g., for monitoring and/or performance evaluation); (vii) concurrently display one or more separate windows, for example, on its GUI; and/or (viii) generate visualizations of the method illustrated in FIG. 4.1-4.2.

One of ordinary skill will appreciate that the visualizer (206) may perform other functionalities without departing from the scope of the embodiments disclosed herein. The visualizer (206) may be implemented using hardware, software, or any combination thereof.

In one or more embodiments, the design engine (202), the rule engine (204), and the visualizer (206) may be utilized in isolation and/or in combination to provide the aforementioned functionalities. These functionalities may be invoked using any communication model including, for example, message passing, state sharing, memory sharing, etc.

Turning now to FIG. 3.1, FIG. 3.1 shows an example UI elements design guideline on language usage in accordance with one or more embodiments disclosed herein. The example, illustrated in FIG. 3.1 and described below, is for explanatory purposes only and not intended to limit the scope disclosed herein.

Referring to FIG. 3.1, the design guideline (which may be part of a design system of a related organization) may recommend using active voice over passive voice. For example, the design guideline may recommend: (i) using “Select the operating system for the server.” instead of “The operating system for the server can be selected.” and (ii) using “System X is backing up the data.” instead of “A backup was performed by system X.”

Turning now to FIG. 3.2, FIG. 3.2 shows an example UI elements design guideline on button styles and usage in accordance with one or more embodiments disclosed herein. The example, illustrated in FIG. 3.2 and described below, is for explanatory purposes only and not intended to limit the scope disclosed herein.

Referring to FIG. 3.2, the design guideline (which may be part of a design system of a related organization) may recommend using different button styles depending on a related button's priority/importance (e.g., in terms of an action that the button represents/triggers).

Turning now to FIG. 3.3, FIG. 3.3 shows an example range of UI elements based on a list of options for a user to select in accordance with one or more embodiments disclosed herein. The example, illustrated in FIG. 3.3 and described below, is for explanatory purposes only and not intended to limit the scope disclosed herein.

Referring to FIG. 3.3, the design guideline (which may be part of a design system of a related organization) may recommend using a single-select dropdown option, a multi-select dropdown option, and/or a combo box option for providing the maximum customer/user satisfaction (e.g., in terms of accessibility).

FIG. 4.1-4.2 show a method for managing UI generation (and/or validation) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 4.1, the method shown in FIG. 4.1 may be executed by, for example, the above-discussed design engine (e.g., 202, FIG. 2), rule engine (e.g., 204, FIG. 2), and visualizer (e.g., 206, FIG. 2). Other components of the system (100) illustrated in FIG. 1 may also execute all or part of the method shown in FIG. 4.1 without departing from the scope of the embodiments disclosed herein.

In Step 400, the design engine receives a request (including at least user input) from a requesting entity (e.g., a user of a client (e.g., 110A, FIG. 1.1) via the client, an administrator terminal, an application, etc.). In one or more embodiments, the user input may be (or may include), for example (but not limited to): text input (where the user just pastes/attaches a message that he/she intended to show in a UI), a screenshot of an already built UI, a URL of a web page (where one or more UI elements are used in the web page), a user story (e.g., a requirement that the user wants to see in a final UI that would be generated), a questionnaire (where the user provides required information that is needed to generate a compliant table (e.g., a number of rows, a number of columns, criticality of data, a color theme, a font type, etc.)), an image of a UI mock (e.g., a layout that shows where to put a button in a UI), a set of requirements that the UI needs to satisfy, etc.

In one or more embodiments, in the request, the user may specify which mode (the suggestion mode or the validation mode) needs to be implemented by the design engine.

In Step 402, in response to receiving the request, as part of the request, and/or in any other manner (e.g., before initiating any computation with respect to the request), the design engine (by employing a set of linear, non-linear, and/or ML models) analyzes the request to (i) determine/identify a type of the user input (e.g., a text, an image, a screenshot, a URL, etc.) and (ii) identify a mode (e.g., the suggestion mode or the validation mode) to operate/implement.

In Step 404, based on analyzing the request (e.g., by considering the type of the user input, by considering the mode that is specified in the request, by considering a type of the user (e.g., a UI developer, a UI tester, etc.), etc.), the design engine makes a first determination (in real-time or near real-time) as to whether the suggestion mode needs to be implemented. Accordingly, in one or more embodiments, if the result of the first determination is YES, the method proceeds to Step 406. If the result of the first determination is NO, the method proceeds to Step 416.

In Step 406, as a result of the first determination in Step 404 being YES (where the design engine operates in the suggestion mode), the design engine makes a second determination (in real-time or near real-time) as to whether the user input includes a data item on which the user wants to obtain a suggestion. Accordingly, in one or more embodiments, if the result of the second determination is YES, the method proceeds to Step 410. If the result of the second determination is NO, the method proceeds to Step 408.

In one or more embodiments, the data item may be, for example (but not limited to): an application button (on a UI) (e.g., a clickable button that initiates a specific action within a related application), a call-to-action button, etc. The user may want to get a suggestion on how the call-to-action button would appear in a UI (e.g., the UI that would be generated/suggested at the end, by the design engine).

In Step 408, as a result of the second determination in Step 406 being NO, the design engine, via the visualizer, instructs the user to provide a data item to get a suggestion on, In Step 410, as a result of the second determination in Step 406 being YES or based on Step 408, the design engine (by employing linear, non-linear, and/or ML models) performs preprocessing on the user input (along with the data item) to obtain preprocessed/structured input. In one or more embodiments, while performing the preprocessing, the design engine may perform, for example (but not limited to): data cleaning (e.g., removal of grammatical plurals), data normalization, data transformation, etc.

In Step 412, based on a set of categories, the design engine (by employing linear, non-linear, and/or ML models (e.g., a natural language processing (NLP) model)) tokenizes the structured input to obtain tokenized data items. As used herein, “tokenization” is the process of breaking down text input into smaller units called “tokens.” In this process, text input (e.g., a sentence) may be split into smaller units that can be more easily assigned meaning.

In Step 414, the design engine provides a copy of the tokenized data items to the rule engine. Following Step 414, the method proceeds to Step 424 of FIG. 4.2.

In Step 416, as a result of the first determination in Step 404 being NO (where the design engine operates in the validation mode), the design engine analyzes (by employing linear, non-linear, and/or ML models) the user input to extract information. In one or more embodiments, the information may specify one or more UI elements, for example (but not limited to): a color palette, a font type of a text, a font size of a text, a text message that is used in the user input (e.g., a screenshot of an already built UI, a web page, etc.), dimensions of an UI element in the user input, etc. Further, by sending the request in Step 400, the user may want to validate UI elements specified in a screenshot of an already built UI against a set of design guidelines.

In one or more embodiments, a set of design guidelines may include, for example (but not limited to): guidelines on user personas, information with respect to accessibility guidelines, guidelines on inclusive language, guidelines on compliant color palettes, etc. Additional details of the guidelines (or of an organizational design system) are described above in reference to FIG. 2.

In Step 418, the design engine provides the information to the rule engine. Upon receiving the information and based on the set of design guidelines, the rule engine (by employing linear, non-linear, and/or ML models) may analyze the information and generate a validation result (with respect to one or more UI elements specified in the information). In one or more embodiments, the validation result may specify, at least, a compliance score of each UI element (e.g., a clarity index score of UI Element A: 89, a Flesch Reading Ease score of UI Element B: 34, a Flesch-Kincaid score of UI Element C: 10, an informality index score of UI Element D: 68, a liveliness index score of UI Element D: 68, etc.).

Further, a compliance score of a UI element may indicate compliance of the UI element with respect to a set of design guidelines that is associated with a type of a customer. For example, for a first customer (e.g., a private equity company) that resides in a first geographical region (which is different from a second geographical region in the world) in the world, the compliance score may indicate compliance of the UI element with respect to a first set of design guidelines (e.g., Indian government compliant design guidelines) that is associated with the first customer. As yet another example, for a second customer (e.g., a federal customer) that resides in the second geographical region in the world, the compliance score may indicate compliance of the UI element with respect to a second set of design guidelines (e.g., European Union compliant design guidelines) that is associated with the second customer.

In Step 420, in response to providing the information (in Step 418), the design engine receives the validation result (with respect to the UI elements specified in the information) from the rule engine. In Step 422, via the visualizer, the design engine initiates display of the validation result (including related compliance scores, if available) to the user (e.g., in response to the request received in Step 400). In one or more embodiments, the method may end following Step 422.

Turning now to FIG. 4.2, the method shown in FIG. 4.2 may be executed by, for example, the above-discussed design engine, rule engine, and visualizer. Other components of the system (100) illustrated in FIG. 1 may also execute all or part of the method shown in FIG. 4.2 without departing from the scope of the embodiments disclosed herein.

In Step 424, in response to providing the copy of the tokenized data items (in Step 414 of FIG. 4.1), the design engine receives a script/code from the rule engine to generate a UI that includes suitable/compliant UI elements. In one or more embodiments, the script may include (at least) a color palette to implement while generating the UI, a text font template to implement while generating the UI, and a text size and a text position template to implement while generating the UI.

In Step 426, the design engine obtains/fetches the set of design guidelines from the database (e.g., 120, FIG. 1). In Step 428, the design engine (by employing linear, non-linear, and/or ML models) compares the tokenized data items against the set of design guidelines. In Step 430, based on the comparison (in Step 428), the design engine (by employing linear, non-linear, and/or ML models) generates a second data item (e.g., the word “Cancel”) to be displayed (and suggested) instead of the data item (e.g., for a UI element, such as the word “Abort”). In one or more embodiments, comparing to the data item, the second data item may include inclusive language.

In Step 432, the design engine (by employing linear, non-linear, and/or ML models) generates the UI based on the second data item and the script. In 434, via the visualizer, the design engine initiates display of UI (generated in Step 432) to the user (e.g., in response to the request received in Step 400). In one or more embodiments, the method may end following Step 434.

Turning now to FIG. 5, FIG. 5 shows a diagram of a computing device in accordance with one or more embodiments disclosed herein.

In one or more embodiments disclosed herein, the computing device (500) may include one or more computer processors (502), non-persistent storage (504) (e.g., volatile memory, such as RAM, cache memory), persistent storage (506) (e.g., a non-transitory computer readable medium, a hard disk, an optical drive such as a CD drive or a DVD drive, a Flash memory, etc.), a communication interface (512) (e.g., Bluetooth interface, infrared interface, network interface, optical interface, etc.), an input device(s) (510), an output device(s) (508), and numerous other elements (not shown) and functionalities. Each of these components is described below.

In one or more embodiments, the computer processor(s) (502) may be an integrated circuit for processing instructions. For example, the computer processor(s) (502) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (e.g., a LAN, a WAN, Internet, mobile network, etc.) and/or to another device, such as another computing device.

In one or more embodiments, the computing device (500) may include one or more output devices (508), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing user interface (UI) generation, the method comprising:
receiving a request from a user via a computing device, wherein the request comprises user input;
analyzing the request to:
determine a type of the user input, and
identify a mode to implement;
making a determination, based on analyzing the request, that a suggestion mode needs to be implemented;
making a second determination, based on the determination, that the user input comprises a data item on which the user wants to obtain a suggestion;
based on the second determination:
performing preprocessing on the user input to obtain structured input;
tokenizing the structured input to obtain tokenized data items, wherein a copy of the tokenized data items is provided to a rule engine;
receiving, in response to providing the copy of the tokenized data items, a script from the rule engine to generate a UI comprising compliant UI elements;
obtaining a set of design guidelines;
comparing the tokenized data items against the set of design guidelines;
generating, based on the comparing, a second data item to be suggested instead of the data item;
generating the UI based on the second data item and the script; and
initiating display of the UI to the user.

2. The method of claim 1, wherein the user specifies which mode needs to be implemented in the request.

3. The method of claim 1, wherein, while making the determination, a type of the user is considered.

4. The method of claim 1,
wherein the data item is a call-to-action button, and
wherein the user wants to get the suggestion on how the call-to-action button would appear in the UI.

5. The method of claim 1, wherein the user input is received in a form of text, an image of a UI mock, or a web page.

6. The method of claim 5, wherein the user input comprises a set of requirements that the UI needs to satisfy.

7. The method of claim 1, wherein the set of design guidelines comprises guidelines on user personas, information with respect to accessibility guidelines, and guidelines on inclusive language.

8. The method of claim 1, wherein, comparing to the data item, the second data item comprises inclusive language.

9. The method of claim 1, wherein the script comprises a color palette to implement while generating the UI, a text font template to implement while generating the UI, and a text size and a text position template to implement while generating the UI.

10. A method for managing user interface (UI) generation, the method comprising:
receiving a request from a user via a computing device, wherein the request comprises user input;
analyzing the request to:
determine a type of the user input, and
identify a mode to implement;
making a determination, based on analyzing the request, that a validation mode needs to be implemented;
based on the determination, analyzing the user input to extract information, wherein the information is provided to a rule engine;
receiving, in response to providing the information, a validation result with respect to UI elements specified in the information from the rule engine; and
initiating display of the validation result to the user.

11. The method of claim 10, wherein the user specifies which mode needs to be implemented in the request.

12. The method of claim 10, wherein, while making the determination, a type of the user is considered.

13. The method of claim 10,
wherein the data item is a screenshot of a UI, and
wherein the user wants to validate UI elements specified in the screenshot against a set of design guidelines.

14. The method of claim 13, wherein the set of design guidelines comprises guidelines on compliant color palettes, information with respect to accessibility guidelines, and guidelines on inclusive language.

15. The method of claim 10, wherein the user input is received in a form of text, an image of a UI, or a web page.

16. A method for managing user interface (UI) generation, the method comprising:
receiving a request from a user via a computing device, wherein the request comprises user input;
analyzing the request to:
determine a type of the user input, and
identify a mode to implement;
making a determination, based on analyzing the request, that a validation mode needs to be implemented;
based on the determination, analyzing the user input to extract information, wherein the information is provided to a rule engine;
receiving, in response to providing the information, a validation result with respect to UI elements specified in the information from the rule engine, wherein the validation result comprises a compliance score of each UI element; and
initiating display of the validation result to the user.

17. The method of claim 16, wherein the user specifies which mode needs to be implemented in the request.

18. The method of claim 16, wherein, while making the determination, a type of the user is considered.

19. The method of claim 16, wherein a compliance score of a UI element indicates compliance of the UI element with respect to a set of design guidelines that is associated with a type of a customer.

20. The method of claim 19,
wherein, for a first customer that resides in a first geographical region in the world, the compliance score indicates compliance of the UI element with respect to a first set of design guidelines that is associated with the first customer,
wherein, for a second customer that resides in a second geographical region in the world, the compliance score indicates compliance of the UI element with respect to a second set of design guidelines that is associated with the second customer, and
wherein the first geographical region is different from the second geographical region.
